(19) United States
(12) Patent Application Publication
(10) Pub. No.: US 2002/0117241 A1
(43) Pub. Date: Aug. 29, 2002

(54) Method of manufacturing Fe-Ni alloy material for pressed flat mask

(76) Inventor: Masatoshi Etoh, Kanagawa-ken (JP)

Correspondence Address: DRINKER BIDDLE & REATH, ONE LOGAN SQUARE, 18TH AND CHERRY STREETS, PHILADELPHIA, PA, 19103-6996, US

(21) Appl. No.: 10/027,316

(22) Filed: Dec. 26, 2001

(30) Foreign Application Priority Data
Dec. 27, 2000 (JP) 2000-397060

(51) Int. Cl. C21D 8/00

(52) U.S. Cl. 148/621

(57) ABSTRACT

A method of manufacturing a Fe-Ni alloy material for pressed flat mask which comprises repeating cold rolling and annealing until final annealing and final cold rolling, the alloy material being composed of, in mass percentage (%),33-37% Ni, 0.001-0.1% Mn, optionally 0.01-2% Co, 0.01-0.8% in total of one or two or more chosen from among 0.01-0.8% Nb, 0.01-0.8% Ta, and 0.01-0.8% Hf, and the balance Fe and unavoidable impurities (the impurities being restricted within the ranges of ≦0.01% C, ≦0.02% Si, ≦0.01% P, ≦0.01% S, and 0.005% N). The press workability of the material is improved by setting the grain size number at the final annealing to 9.0-12.0 and also setting the reduction ratio of the final cold rolling to 40-75%.

### BACKGROUND OF THE INVENTION

1. Field of the Invention

This invention relates to a method of manufacturing a Fe-Ni alloy material for pressed flat mask. More particularly; the invention relates to a method of manufacturing a Fe-Ni alloy aterial with a press workability improved by controlling the softening properties prior to pressing while maintaining the low thermal expansion and drop impact deformation resistance of the Fe-Ni alloy for pressed flat mask through the choice of specific kinds and concentrations of elements to be added, the reduction ratio of the final cold rolling, and the control of the grain size (number) at the final annealing.

2. Prior Art

In a color picture tube, electron guns produce electron beams that strike fluorescent-dot screen mounted behind a glass panel to display a color image. A deflection yoke magnetically controls the directions of the electron beams. Behind the glass panel is located a mechanism, known as a mask, for classifying the electron beams into predetermined pixel units that strike desired fluorescent dots. Masks for picture tubes are roughly divided into two types; shadow mask type that is made by forming dots or slots for the passage of electron beams in a mask workpiece by etching and then press working the workpiece to a mask shape, and aperture grille type made by forming elongated slits for the passage of electron beams in a mask workpiece by etching and then pulling the workpiece vertically and tentering or stretching it on a frame. Both types, with merits and demerits, are available on the market.

Meanwhile, many attempts have thus far been made to develop flattened picture tubes with flat screens. By a flat screen is meant a display screen nearly completely flattened instead of being spherical as at present. A major problem to be solved in the attempt to flatten the picture tube screen is how to make the shadow mask or aperture grill as flat as possible. Difficulties are involved in either case. In general, it is believed basically more difficult to fabricate a flat mask by pressing a shadow mask workpiece to a nearly flat surface than by stretching as in making an aperture grill (cf. NIKKEI ELECTRONICS, Jul. 26, 1999 (No. 748), p. 128).

The shadow mask, unlike the stretched one, must retain its shape by itself because it is fabricated by pressing a metal sheet blank, and basically the shape retention is impossible unless the mask is spherically shaped. In particular, the flat mask that is nearly completely flattened is harder to retain its shape. The only possible solution to this problem is enhancing the mask strength. The term “mask strength” as used herein differs in meaning from the strength that applies to ordinary metals (e.g., the strength as determined by a tensile test); it indicates whether a mask in an assembled picture tube undergoes a deformation or not upon subjection of the whole tube to a predetermined impact. To be more concrete, the test picture tube is dropped from a predetermined height and the mask is inspected to see if it has been deformed. The development of such a mask resistant to impact deformation or that which is improved in the drop impact deformation resistance is deemed necessary for flat tubes. For the evaluation of the drop impact deformation resistance the Young's modulus and the yield strength of the mask material are known to be the most influential factors.

The flat tube is also required to possess excellent doming characteristics. The closer the mask shape toward flatness from the spherical the acuter the angles of incidence of electron beams from the electron guns at the four corners of the mask. This means that a slight deviation of the mask from the place owing to thermal expansion results in “mislanding” of the electron beams, presenting a problem of colors out of register. It calls for the development of a low-expansion mask with by far the lower thermal expansion than existing masks. A flat mask is required to attain a mean thermal expansion coefficient of not greater than 12×10⁻⁷/° C. at 30-100° C.

Shadow mask materials that have heretofore been used have basic alloy compositions of Fe-33˜37% Ni with the addition of Mn to compensate for the deterioration of hot workability due to the S content. The addition of Mn increases the thermal expansion coefficient of the resulting alloy, and yet, as noted above, it is essential for a flat mask to attain a mean thermal expansion coefficient of not greater than 12×10⁻⁷/° C. at 30-100° C.

Thus, pressed flat masks demand far lower thermal expansion and far better drop impact deformation resistance than conventional masks.

In view of the foregoing, the present applicant previously proposed, in Japanese Patent Application No. 2000-192249, an alloy based on a Fe-Ni alloy composition but which is reduced in the proportion of Mn that increases the thermal expansion coefficient, with the addition of a proper amount of Co as needed in proportion to Ni aimed at attaining a high yield strength, with the further addition of proper amounts of Nb, Ta, and Hf. preferably with reduced impurity contents, that is, a Fe-Ni alloy comprising from 33 to 37% Ni, from 0.001 to 0.1% Mn, optionally from 0.01 to 2% Co, and from 0.01 to 0.8 in total of one or two or more selected from among from 0.01 to 0.8% Nb, 0.01 to 0.8% Ta, and from 0.01 to 0.8% Hf (impurities being restricted within the ranges of ≦0.01% C, ≦0.02% Si, ≦0.01% P, ≦0.01% S, and 0.005% N).

The alloy possessed excellent properties for use in flat masks but was later found to pose a new problem. Its high softening temperature keeps the alloy from being sufficiently softened on annealing before press working that it could not eventually be pressed. It is a vital problem for flat masks of the pressed type. A shadow mask material is made by melting an alloy of a desired composition, casting the melt into an ingot, forging the ingot and hot rolling it into a coil, and then repeating cold rolling and bright annealing until final annealing and final cold rolling are carried out to obtain a cold rolled sheet about -0.1to 0.25 mm thick, and lastly slitting the sheet into strips of a given width. The shadow mask material is then degreased, coated with photoresist on both sides, baked with a pattern, developed, perforated by etching, and then cut into pieces as shadow mask blanks. The blanks are then subjected to annealing in a non-oxidizing atmosphere, e.g., a reducing atmosphere (at 750 to 900° C. for 30 min. in hydrogen) to impart press workability. After passage through a leveler when necessary, the blanks are pressed to substantially flat masks. The prior art material showed such a tendency of high softening temperature during the annealing before press working that it could not eventually be pressed.

This invention has for its object to provide a method of manufacturing a Fe-Ni alloy material for pressed flat mask, with sufficient press workability imparted to the alloy by annealing prior to pressing.

### SUMMARY OF THE INVENTION

The present inventor has studied the manufacturing conditions whereby the rise of the softening temperature of the alloy is restricted and adequate press workability is imparted to the alloy by annealing before pressing. It has now been found, as a result, that the softening anneal characteristics of the alloy before pressing are such that the press workability is improved when the 0.2% yield strength after annealing at 750 to 900° C. is not more than 400 N/mm² and, to realize it, adjustments of the grain size upon final annealing and the cold reduction ratio of the final cold rolling are important. Proper ranges for the adjustments have now been found.

Thus, the present invention provides a method of manufacturing a Fe-Ni alloy material for pressed flat mask which comprises repeating cold rolling and annealing until final annealing and final cold rolling, the alloy material being composed of, in mass percentage (%), from 33 to 37% Ni, from 0.001 to 0.1% Mn, optionally from 0.01 to 2% Co, from 0.01 to 0.8% in total of one or two or more chosen from among from 0.01 to 0.8% Nb, from 0.01-0.8% Ta, and from 0.01 to 0.8% Hf, and the balance Fe and unavoidable impurities (the impurities being preferably restricted within the ranges of ≦0.01% C, ≦0.02% Si, ≦0.01% P, ≦0.01% S, and 0.005% N), the method being characterized in that the press workability of the material is improved by setting the grain size number at the final annealing to from 9.0 to 12.0 and also setting the reduction ratio of the final cold rolling to from 40 to 75%.

### BRIEF DESCRIPTION OF THE DRAWING

FIG. 1 is a graph showing annealing-softening curves of some test specimens of an example of the invention and of comparative examples, with heating temperature as abscissa and 0.2% yield strength as ordinate. The heating time for annealing was 30 minutes, and the annealing was conducted in a hydrogen gas atmosphere.

### DETAILED DESCRIPTION OF THE INVENTION

For the purposes of the invention the term “for pressed flat mask” is intended to apply specifically to the afore-described alloy composition having by far the lower thermal expansion and the greater drop impact deformation resistance than conventional mask materials.

The softening anneal characteristics of the alloy material prior to press working are such that the 0.2% yield strength after annealing from 750 to 900° C. satisfies the condition of not greater than 400 N/mm².

In the process for manufacturing the mask material, an alloy of a predetermined composition is melted, e.g., in a vacuum induction melting (VIM) furnace, the melt is cast into an ingot, and the ingot is forged and subjected to multi-pass hot rolling, going through from 8 to 16 passes, from 150 mm thickness to a coil form about 3 mm thickness. The coil is then repeatedly cold rolled and bright annealed, and by way of final annealing and final cold rolling, it is reduced to a cold rolled sheet from about 0.1 mm to about 0.25 mm. The sheet is slitted into strips of a predetermined width as shadow mask strips. The mask strips are then degreased and coated with a photoresist on both sides, exposed to light for patterning After developing, the strips are perforated by etching and cut into pieces as shadow mask blanks.

The shadow mask blanks are then annealed in a non-oxidizing atmosphere, e.g., a reducing atmosphere (at 750 to 900° C. for 30 min. in hydrogen) to impart press workability. After passage through a leveler when necessary, the blanks are pressed to substantially flat masks. Lastly, pressed flat masks are degreased and blackened in air or CO/CO₂ gas atmosphere to form a black oxide film on the surface.

The invention is aimed at imparting adequate press workability to the shadow mask blanks for the annealing in a nonoxidizing atmosphere (at 750 to 900° C. for 30 min., e.g., in hydrogen).

The pressed “flat mask” according to this invention has a nearly completely flat shape, e.g., with an outer surface radius of curvature R of not less than 100,000 mm and a flatness, in terms of the maximum height of the curved screen surface divided by the effective screen diagonal, of not greater than 0.1%.

The pressed flat mask of the invention possesses a Young's modulus of not less than 120,000 N/mm² and a 0.2% yield strength of not less than 300 N/mm² after the annealing that imparts the press workability while maintaining the mean thermal expansion coefficient of not greater than 12×10⁻⁷/° C. in the temperature range of 30 to 100° C. With a Young's modulus of not less than 120,000 N/mm² and a 0.2% yield strength of not less than 300 N/mm², the mask in a completely flat picture tube will not be deformed when subjected to the afore-described picture tube drop test.

When the 0.2% yield strength of the mask blank after the annealing at 750 to 900° C. is below 400 N/mm² the press workability of the blank is desirable.

Thus, in view of the mask strength (prevention of the deformation) and press workability, it is specified here that the 0.2 yield strength of the blank after the annealing at 750 to 900° C. should come within the range of 300 to 400 N/mm².

The present invention is characterized in that a low thermal expansion Fe-Ni alloy whose low thermal expansion property has beer enhanced by the reduction of the Mn content and which is based on an alloy composition containing proper amounts of Nb, Ta, and Hf as well as Co as elements added to increase the yield strength and Young's modulus in order to improve the drop impact deformation resistance without increasing the thermal expansion, is improved in press workability by setting the grain size number at the final annealing to a range between 9.0 and 12.0 and the reduction ratio of the final cold rolling to a range between 40 and 75%.

The grounds on which various limitations are placed on the alloying elements and manufacturing conditions under the invention will now be explained.

(Basic Elements)

Ni:—The Ni content is specified to be in the range from 33 to 37%, preferably from 34 to 36%, lest it should produce noxious structures such as martensite but it should achieve a low thermal expansion through a synergistic effect with Co.

Co:—Co lowers thermal expansion while it serves to improve the yield strength. On these grounds it is usually believed necessary to add at least 0.01%, but a Co addition of more than 2% is out of balance with the Ni content, raising the thermal expansion to a disadvantage. Moreover, the excessive Co addition is not advisable from the cost reason. In general, where the Ni consent is rather large (over 35.5%), the Co addition may be a trace of less than 0.01% or reduced to nil. In this sense Co is specified as an optionally added element. For the purposes of the invention it is desirable to add Co in the range from 0.1 to 2%, preferably from 0.5 to 2%.

Mn:—Mn is added as a deoxidizer. Since it raises the coefficient of thermal expansion, it is deemed necessary to limit the Mn range from 0.001 to 0.1%, preferably from 0.001 to 0.05 so as to attain a mean thermal expansion coefficient at 30 to 100° C. of not greater than 12×10⁻⁷/° C.

(Additional Elements)

Nb, Ta, Hf:—These are added as elements that achieve synergistic effects with the addition of Co to attain desired high yield strength without raising the thermal expansion of the resulting alloy, even with a further improvement in Young's modulus. If the addition of such an element or elements is less than 0.01% there is no beneficial effect, whereas the addition of more than 0.8% deteriorates the etchability and raises the thermal expansion. Any of the elements added alone should amount to from 0.01 to 0.8% and all of them should also amount in total to from 0.01 to 0.8%.

(Impurities) C:—C in an amount larger than 0.01% forms a carbide to excess and thereby deteriorates the etchability of the resulting alloy. Therefore, the C content should be not larger than 0.01%, preferably not larger than 0.006%.

Si:—Si has a deoxidizing effect, but more than 0.02% Si results in a material deterioration of the etchability. Not more than 0.02% is a desirable range.

P:—Excessive P causes inferior etching. The P content should be kept below 0.01%, preferably below 0.005%.

So:—S in excess of 0.01% has a detrimental effect upon hot workability, while forming much sulfide inclusions which, in turn, impair etchability. Hence the upper limit of 0.01% , preferably 0.005%.

N:—N forms compounds with Nb, Ta, and Hf to affect the hot workability and etchability of the resulting alloy. It therefore is desirable to limit the N content to not more than 0.05%, more desirably to not more than 0.003%.

MnS and P segregations, for example, extend linearly after rolling, because of their ductility. They mar the rim shape of etched apertures such as dots and slots. In order to avoid the deterioration of the etchability, control of these impurities is required.

(Manufacturing Conditions)

(A) Grain size (number) at final annealing:- The grain size number at the final annealing is limited within the range from 0.9 to 12.0, preferably from 10.0 to 12.0. This ensures good press workability as a result of the annealing that imparts press workability to the alloy material after etching. If the grain number is less than 9.0 the above annealing will not give adequate press workability, whereas a grain number beyond 12.0 will not produce a uniform recrystallization structure but will give a duplex grain or unrecrystallized structure which, in turn, forms unwanted stripes or unevenness at the time of etching.

(B) Reduction ratio of the final cold rolling:- The reduction ratio of the final cold rolling is specified to be between 40 and 75%, preferably between 50 and 60%. In this way good press workability is attained by the annealing that imparts pressability after etching. If the reduction ratio is less than 40% the annealing will not give good press workability, whereas a reduction ratio over 75% will cause the etching to produce unwanted stripes or unevenness, impairing the performance of the resulting mask.

In view of (A) and (B) above, the softening anneal before press working should be carried out at an annealing temperature at 750° C.-900° C. so as to achieve the objective 0.2% yield strength of from 300 to 400 N/mm².

[Working Examples]

Reference examples that suggest the importance of the alloy composition according to the present invention and working examples and comparative examples indicative of the significance of the manufacturing conditions under the invention will be given below.

(Reference Examples)

Table 1 shows alloy compositions according to examples of the invention and comparative alloy compositions. Each alloy of the compositions listed was melted in a vacuum induction melting (VIM) furnace. The ingot so obtained was forged, and hot rolled to a sheet 3 mm thick, and then repeatedly cold rolled and bright annealed. With the grain size number at final annealing set to from 10.0 to 10.5 and the reduction ratio of the final cold rolling set to 50%, a cold rolled sheet about 0.12 mm thick was obtained. The sheet was slitted into strips of a given width, and the shadow mask blanks thus obtained were annealed in a reducing atmosphere (at 800° C. for 30 min. in hydrogen) to impart press workability.

TABLE 1

| | | | | | | | | | | | |
|---|---|---|---|---|---|---|---|---|---|---|---|
| Alloy No. | Ni | Mn | C | Si | P | S | N | Co | Nb | Ta | Hf |

Example of the invention

| | | | | | | | | | | | |
|---|---|---|---|---|---|---|---|---|---|---|---|
| 1 | 35.9 | 0.01 | 0.004 | 0.01 | 0.002 | 0.001 | 0.0025 | <0.01 | 0.31 | <0.001 | <0.001 |
| 2 | 34.7 | 0.03 | 0.003 | 0.01 | 0.003 | 0.001 | 0.0030 | 1.55 | 0.29 | <0.001 | <0.001 |
| 3 | 35.5 | 0.04 | 0.003 | 0.02 | 0.003 | 0.002 | 0.0019 | <0.01 | <0.001 | 0.32 | <0.001 |
| 4 | 36.0 | 0.02 | 0.005 | <0.01 | 0.002 | 0.001 | 0.0020 | <0.01 | <0.001 | <0.001 | 0.27 |
| 5 | 35.4 | 0.05 | 0.003 | <0.01 | 0.002 | 0.002 | 0.0018 | <0.01 | 0.18 | 0.12 | 0.10 |
| 6 | 36.0 | 0.05 | 0.003 | 0.01 | 0.002 | 0.003 | 0.0022 | <0.01 | <0.001 | 0.20 | 0.25 |
| 7 | 34.5 | 0.02 | 0.002 | 0.01 | 0.001 | 0.000 | 0.0030 | 1.40 | 0.13 | 0.14 | 0.13 |
| 8 | 35.0 | 0.02 | 0.003 | 0.01 | 0.002 | 0.011 | 0.0033 | <0.01 | 0.33 | <0.001 | <0.001 |
| 9 | 35.4 | 0.03 | 0.013 | 0.01 | 0.002 | 0.002 | 0.0022 | 0.90 | <0.001 | 0.35 | <0.001 |
| 10 | 34.6 | 0.04 | 0.003 | 0.11 | 0.003 | 0.002 | 0.0035 | 1.55 | <0.001 | <0.001 | 0.45 |
| 11 | 36.2 | 0.03 | 0.004 | <0.01 | 0.016 | 0.001 | 0.0040 | <0.01 | 0.37 | 0.15 | <0.001 |
| 12 | 35.9 | 0.02 | 0.003 | <0.01 | 0.003 | 0.003 | 0.0070 | 0.90 | 0.30 | <0.001 | 0.20 |

Comparative example

| | | | | | | | | | | | |
|---|---|---|---|---|---|---|---|---|---|---|---|
| 13 | 36.0 | 0.32 | 0.003 | 0.01 | 0.003 | 0.002 | 0.0025 | <0.01 | 0.31 | 0.17 | 0.15 |
| 14 | 35.7 | 0.03 | 0.004 | 0.01 | 0.002 | 0.003 | 0.0032 | 3.35 | 0.29 | <0.001 | <0.001 |
| 15 | 35.5 | 0.03 | 0.004 | <0.01 | 0.002 | 0.002 | 0.0037 | <0.01 | <0.001 | <0.001 | <0.001 |
| 16 | 32.1 | 0.03 | 0.003 | <0.01 | 0.003 | 0.001 | 0.0029 | <0.01 | 0.35 | 0.15 | <0.001 |
| 17 | 38.9 | 0.05 | 0.003 | 0.01 | 0.002 | 0.001 | 0.0033 | <0.01 | <0.001 | 0.35 | <0.001 |
| 18 | 36.3 | 0.03 | 0.004 | 0.01 | 0.002 | 0.002 | 0.0029 | <0.01 | 0.40 | 0.70 | <0.001 |
| 19 | 35.9 | 0.02 | 0.002 | <0.01 | 0.003 | 0.002 | 0.0036 | 1.50 | 0.29 | 0.35 | 0.40 |

The materials after annealing were subjected to a tensile test to determine their tensile strength and 0.2% yield strength. Also, a flexural resonance method was carried out in conformity with the testing procedure of JIS R 1605 to find their Young's modulus values.

The flexural resonance method consists in suspending a test specimen with a yarn sagging from both a driver and a detector to allow the piece to undergo free flexural oscillation, applying driving forces from an oscillator to the upper and lower surfaces of the test specimen, measuring the maximum amplitude and node of oscillation through the detector to determine the primary resonance frequency, and calculating the dynamic elastic modulus from the primary resonance frequency and the mass and dimensions of the test specimen in accordance with a given formula.

In addition, the mean thermal expansion coefficient of the test specimen in the temperature range from 30 to 100° C. was measured.

Each test specimen about 0.12 mm thick after the final cold rolling was sprayed on the surface with a 45 B\overline{e} aqueous solution of ferric chloride at 60° C. and at a pressure of 0.3 MPa, and its one side surface was etched to a depth of about 50 μm, and then the etched surface condition was examined.

The results are summarized in Table 2.

TABLE 2

| | | | | | |
|---|---|---|---|---|---|
| | | 0.2% Yield | | Mean. therm expan. coeff | |
| | Tens. str. | Strength | Young's modulus | (Measmt. range 30˜100° | Etched surface |
| Alloy No. | N/mm² | N/mm² | N/mm² | C. × 10⁻⁷/° C. | condition |

Example of the invention

| | | | | | | | | |
|---|---|---|---|---|---|---|---|---|
| 1 | 682 | 325 | (◯) | 126000 | (◯) | 8.9 | (◯) | (◯) |
| 2 | 711 | 332 | (◯) | 129000 | (◯) | 8.0 | (◯) | (◯) |
| 3 | 680 | 320 | (◯) | 124000 | (◯) | 8.6 | (◯) | (◯) |
| 4 | 678 | 328 | (◯) | 128000 | (◯) | 9.1 | (◯) | (◯) |
| 5 | 703 | 335 | (◯) | 130000 | (◯) | 9.7 | (◯) | (◯) |
| 6 | 720 | 337 | (◯) | 134000 | (◯) | 9.0 | (◯) | (◯) |
| 7 | 765 | 352 | (◯) | 141000 | (◯) | 8.9 | (◯) | (◯) |
| 8 | 680 | 322 | (◯) | 124000 | (◯) | 8.8 | (◯) | (Δ) |
| 9 | 745 | 330 | (◯) | 134000 | (◯) | 9.8 | (◯) | (Δ) |
| 10 | 700 | 337 | (◯) | 130000 | (◯) | 9.6 | (◯) | (Δ) |
| 11 | 715 | 342 | (◯) | 137000 | (◯) | 9.9 | (◯) | (Δ) |
| 12 | 768 | 355 | (◯) | 143000 | (◯) | 10.9 | (◯) | (Δ) |

Comparative example

| | | | | | | | | |
|---|---|---|---|---|---|---|---|---|
| 13 | 755 | 344 | (◯) | 142000 | (◯) | 14.8 | (×) | (◯) |
| 14 | 703 | 320 | (◯) | 128000 | (◯) | 13.7 | (×) | (◯) |
| 15 | 561 | 272 | (×) | 116000 | (×) | 8.0 | (◯) | (◯) |
| 16 | 685 | 318 | (◯) | 125000 | (◯) | 26.0 | (×) | (◯) |
| 17 | 682 | 325 | (◯) | 126000 | (◯) | 38.1 | (×) | (◯) |
| 18 | 779 | 370 | (◯) | 146000 | (◯) | 15.0 | (×) | (×) |
| 19 | 770 | 360 | (◯) | 145000 | (◯) | 14.9 | (×) | (×) |

Alloy Nos. 1 to 6 according to the present invention (claim 1) possessed thermal expansion coefficients not exceeding the permissible level (12×10⁻⁷/° C.), and their Young's modulus and 0.2% yield strength values were well within the objective ranges, respectively, of not less than 120,000 N/mm² and not less than 300 n/mm². Alloy No. 7, in particular, realized a Young's modulus of more than 140,000 N/mm² and, at the same time, a 0.2% yield strength of more than 350 N/mm². With both the Mn and impurity contents within the specified ranges, all the test alloys indicated good etched surface conditions.

Alloy Nos. 8 to 12 of the invention (claim 2) showed somewhat inferior etched surface conditions because of their more than specified contents of impurities, S, C, Si, P, and N, but the surface conditions were no problem for the use of the alloys. They all met the target requirements of 0. 2% yield strength, Young's modulus, and mean thermal expansion coefficient.

On the other hand, Alloy No. 13, which contained greater than 0.1% Mn, exhibited a high mean thermal expansion coefficient.

Alloy No. 14, which contained 2.0% Co, also had a high mean thermal expansion coefficient because of the balance between the Co and Ni contents.

Without the addition of Nb, Ta, and Hf, Alloy No. 15 was seriously inferior in strength properties.

Both Alloy Nos. 16 and 17, with Ni contents outside the range from 33 to 37%, exhibited high mean thermal expansion coefficients.

Alloy Nos. 18 and 19 too showed high mean thermal expansion and poor etched surfaces, because Alloy No. 18 had a combined Nb and Ta content in excess of 0.8% and Alloy No. 19 had a combined Nb-Ta-Hf content of more than 0.8%.

### (EXAMPLES)

Table 3 shows the compositions of alloys according to the invention that were tested under the manufacturing conditions of the invention. Alloy Nos. 1 to 4 were all of the compositions, including the impurities, within the ranges specified under the invention. Alloy No. 5 contained no additional element of Co, Nb, Ta, or Hf.

TABLE 3

| Alloy No. | Ni | Mn | S | C | Si | P | N | Co | Nb | Ta | Hf |
|---|---|---|---|---|---|---|---|---|---|---|---|
| 1 | 36.2 | 0.02 | 0.002 | 0.003 | 0.01 | 0.002 | 0.0025 | <0.01 | 0.33 | <0.01 | <0.01 |
| 2 | 35.7 | 0.06 | 0.002 | 0.004 | 0.02 | 0.003 | 0.0031 | 0.02 | 0.35 | 0.24 | <0.01 |
| 3 | 34.0 | 0.02 | 0.001 | 0.003 | 0.02 | 0.002 | 0.0022 | 1.85 | 0.29 | 0.20 | 0.12 |
| 4 | 33.9 | 0.01 | 0.001 | 0.005 | <0.01 | 0.006 | 0.0033 | 1.75 | <0.01 | 0.25 | 0.24 |
| 5 | 36.1 | 0.02 | 0.002 | 0.004 | <0.01 | 0.003 | 0.0028 | <0.01 | <0.01 | <0.01 | <0.01 |

The alloys of the compositions listed above were each melted in a vacuum induction melting (VIM) furnace, the melts were cast, the resulting ingots were forged and hot rolled to sheets 3 mm thick, and the sheets were repeatedly cold rolled and bright annealed. The grain size number at the final annealing was set to the range from 7.0 to 11.0 and the reduction ratio of the final cold rolling was set to the range from 15 to 35%, and cold rolled materials about 0.12 mm thick were obtained. Test specimens for etching tests were sampled from those cold rolled materials. The cold rolled materials were slitted into strips of a predetermined width, and the shadow mask blanks so obtained were annealed in a reducing atmosphere (at 800° C. for 30 min. in hydrogen) to impart press workability. Mechanical property (0.2% yield strength) and physical properties (Young's modulus and thermal expansion coefficient) of these test specimens were determined.

Test specimens obtained by varying the grain size number at the time of final annealing and the reduction ratio of the final cold rolling of Alloy Nos. 1 to 5 were tested for their properties, and the results are given in Table 4. 0.2% yield strength is required to be not more than 400 N/mm² from the viewpoint of press workability and not less than 300 N/mm² from the viewpoint of mask strength. Hence the target value of 0.2% yield strength is in the range from 300 to 400 N/mm². Young's modulus should be not less than 120,000 N/mm² from the viewpoint of mask strength, and the target value of mean thermal expansion coefficient is not more than 12×10⁻⁷/° C. As for etchability, the test specimen was sprayed on the surface with a 45 B\overline{e} aqueous solution of ferric chloride at 60° C. and at a pressure of 0.3 MPa, and its etched surface conditions were examined and evaluated by visually observing whether there was unwanted stripes or unevenness or not.

TABLE 4

| | | | | | | | |
|---|---|---|---|---|---|---|---|
| | | Grain | Final | 0.2% Yield | Young's | Mean. therm. expan. coeff. | Etched |
| Example | Alloy | size | Reduction | Strength | modulus | (Measmt range 30˜100° | surface |
| No. | No. | GS No. | ratio % | N/mm² | N/mm² | C. × 10⁻⁷/° C. | condition |

Example of the invention

| | | | | | | | | | | |
|---|---|---|---|---|---|---|---|---|---|---|
| 1 | 1 | 9.0 | 50 | 325 | (◯) | 130000 | (◯) | 8.5 | (◯) | ◯ |
| 2 | 1 | 10.5 | 55 | 330 | (◯) | 132000 | (◯) | 8.7 | (◯) | ◯ |
| 3 | 2 | 9.5 | 50 | 330 | (◯) | 136000 | (◯) | 9.3 | (◯) | ◯ |
| 4 | 2 | 11.0 | 60 | 335 | (◯) | 135000 | (◯) | 9.5 | (◯) | ◯ |
| 5 | 3 | 10.0 | 45 | 340 | (◯) | 134000 | (◯) | 8.2 | (◯) | ◯ |
| 6 | 3 | 11.0 | 55 | 348 | (◯) | 137000 | (◯) | 8.1 | (◯) | ◯ |
| 7 | 4 | 9.0 | 45 | 355 | (◯) | 142000 | (◯) | 9.2 | (◯) | ◯ |
| 8 | 4 | 10.5 | 55 | 360 | (◯) | 145000 | (◯) | 9.5 | (◯) | ◯ |

Comparative example

| | | | | | | | | | | |
|---|---|---|---|---|---|---|---|---|---|---|
| 9 | 5 | 9.5 | 20 | 270 | (×) | 110000 | (×) | 7.5 | (◯) | ◯ |
| 10 | 5 | 7.0 | 45 | 275 | (×) | 112000 | (×) | 7.8 | (◯) | ◯ |
| 11 | 5 | 10.0 | 55 | 280 | (×) | 113000 | (×) | 8.1 | (◯) | ◯ |
| 12 | 1 | 7.0 | 50 | 410 | (×) | 132000 | (◯) | 8.7 | (◯) | ◯ |
| 13 | 2 | 7.0 | 55 | 425 | (×) | 135000 | (◯) | 9.2 | (◯) | ◯ |
| 14 | 3 | 7.5 | 45 | 450 | (×) | 137000 | (◯) | 8.4 | (◯) | ◯ |
| 15 | 4 | 10.0 | 25 | 462 | (×) | 141000 | (◯) | 9.2 | (◯) | ◯ |
| 16 | 1 | 10.5 | 15 | 430 | (×) | 130000 | (◯) | 8.8 | (◯) | ◯ |
| 17 | 2 | 10.0 | 85 | 330 | (◯) | 136000 | (◯) | 9.0 | (◯) | × |
| 18 | 3 | 9.5 | 80 | 341 | (◯) | 135000 | (◯) | 8.2 | (◯) | × |
| 19 | 1 | 7.0 | 20 | 525 | (×) | 137000 | (◯) | 8.5 | (◯) | ◯ |
| 20 | 4 | 7.0 | 85 | 420 | (×) | 143000 | (◯) | 9.1 | (◯) | × |

Example Nos. 1 to 8 of the present invention attained the target values, with the grain size number at: the final annealing and the reduction ratio of final cold rolling within the ranges specified under the invention and with fairly satisfactory thermal expansion coefficients and etched surface conditions.

Comparative Example Nos. 9 to 11, without the addition of any of Co, Nb, Ta, and Hf, showed inadequate 0.2% yield strength and Young's modulus values.

Comparative Example Nos. 12 to 14 were inferior in press workability with their 0.2% yield strength values above the target level, because their grain size numbers at the final annealing were outside the range specified by the invention, though to slight degrees.

Comparative Example Nos. 15 and 16 too were inferior in press workability with excessive 0.2% yield strength, because their reduction ratios of final cold rolling were slightly off the range of the invention.

Comparative Example Nos. 17 and 8 whose reduction ratios of final cold rolling were far outside the range of the invention showed objectionable stripes or unevenness when they were inspected for etchability.

Comparative Example Nos. 19 and 20 were both inferior in press workability and No. 20 showed poor etchability two, because their grain size numbers at the final annealing and reduction ratios of the final cold rolling were both outside the ranges specified by the invention.

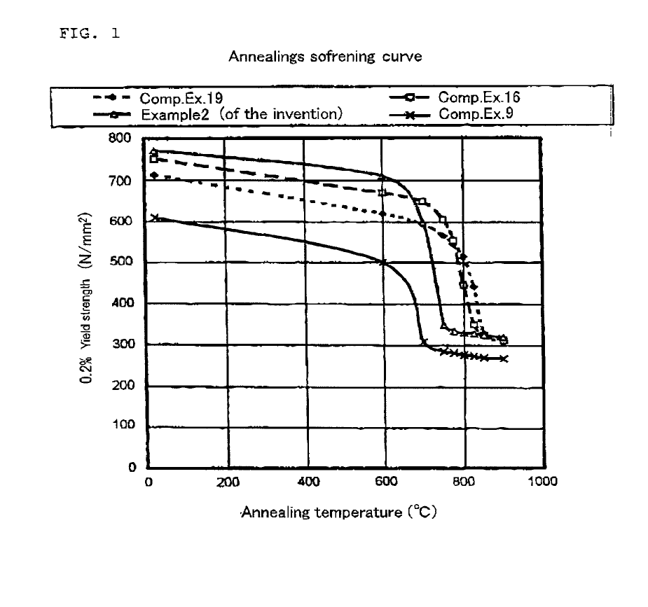

Annealing softening curves of some alloys of Examples of the invention and Comparative Examples are given in FIG. 1.

Example No. 2 (of the invention) satisfactorily hit the target of 0.2% yield strength, in the range from300 to 400 N/mm² at annealing temperatures above 740° C.

Comparative Example Nos. 16 and 19 were outside the ranges specified under the invention in respect of the grain size number at the final annealing and the reduction ratio of the final cold rolling. They were inferior in press workability, therefore, with the 0.2% yield strength values in excess of 400 N/mm².

Comparative Example No. 9, free from Nb, Ta, Hf or the like, showed a grain size number at the final annealing outside the range of the invention. It had a 0.2% yield strength of less than 300 N/mm² at an annealing temperature above 700° C., and therefore was inferior in mask strength.

According to the invention, as has been described hereinabove, the Mn content in a Fe-Ni alloy that contains an adequate concentration of nickel is kept low, and an appropriate amount of Co is added to attain low thermal expansion while a proper amount of Nb, Ta, and/or Hf is added to make up for insufficient resistance to drop impact deformation. On the basis of the resultant alloy, a Fe-Ni alloy material with excellent drop impact deformation resistance and press workability for pressed flat mask can be obtained by a manufacturing process under the optimum conditions set to the grain size number at the final annealing to from 9.0 to 12.0 and the reduction ratio of final cold rolling to from 40 to 75%. In this way a desirable pressed type flat mask which has no possibility of color mislanding or out of register and which undergoes no deformation during the course of handling to meet the requirements of flat type color picture tubes of the future, can now be manufactured at high yield.

What is claimed is:

1. A method of manufacturing a Fe-Ni alloy material for pressed flat mask which comprises repeating cold rolling and annealing until final annealing and final cold rolling, the alloy material being composed of, in mass percentage (%), from 33 to 37% Ni, from 0.001 to 0.1% Mn, optionally from 0.01 to 2% Co, from 0.01 to 0.8% in total of one or two or more chosen from among from 0.01 to 0.8% Nb, from 0.01 to 0.8% Ta, and from 0.01 to 0.8% Hf, and the balance Fe and unavoidable impurities, the method being characterized in that the press workability of the material is improved by setting the grain size number at the final annealing to from 9.0 to 12.0 and also setting the reduction ratio of the final cold rolling to from 40 to 75%.

2. The method according to claim 1, in which the impurities in the Fe-Ni alloy material are restricted within the ranges of ≦0.01% C, ≦0.02% Si, ≦0.01% P, ≦0.01% S, and 0.005% N.
